(19) United States
(12) Patent Application Publication
(10) Pub. No.: US 2024/0418200 A1
(43) Pub. Date: Dec. 19, 2024

(54) TELESCOPE SYSTEM AND METHOD

(71) Applicants: James Alan Monroe, Syracuse, NY (US); Jeremy Sean McAllister, New York, NY (US); Jay Russell Zgarba, Sugar Land, TX (US)

(72) Inventors: James Alan Monroe, Syracuse, NY (US); Jeremy Sean McAllister, New York, NY (US); Jay Russell Zgarba, Sugar Land, TX (US)

(21) Appl. No.: 18/814,485

(22) Filed: Aug. 24, 2024

Related U.S. Application Data
(63) Continuation-in-part of application No. 17/981,406, filed on Nov. 5, 2022, now Pat. No. 12,071,969.
(63) Continuation-in-part of application No. 17/981,407, filed on Nov. 5, 2022, now Pat. No. 12,071,970.
Application No. 16/735,587 is a continuation-in-part of application No. 15/963,428, filed on Apr. 26, 2018, now Pat. No. 11,125,966.
Application No. 15/963,428 is a continuation-in-part of application No. 15/217,594, filed on Jul. 22, 2016, now Pat. No. 10,822,670.
Application No. 15/217,594 is a continuation-in-part of application No. 14/897,904, filed on Dec. 11, 2015, now Pat. No. 10,557,182.
(60) Provisional application No. 62/490,877, filed on Apr. 27, 2017.
(60) Provisional application No. 61/835,289, filed on Jun. 14, 2013.

(51) Int. Cl. F16B 31/04; C21D 7/00; C22F 1/18; F16B 31/00; F16B 31/06; F16B 43/00

(52) U.S. Cl. CPC F16B 31/04; C22F 1/183; F16B 31/007; F16B 31/06; F16B 43/001; C21D 7/00

(57) ABSTRACT

A series tailored athermally stabilized optical (STASO) telescope system (STASOS) and method (STASOM) is disclosed. The disclosed system/method separates an optical mirror source (OMS) and an optical focal target (OFT) via a series connection of a first metering tube (FMT) and a second metering tube (SMT) that have been selected to have complementary thermal expansion characteristics so as to keep the OMS and OFT at a predetermined optical focal distance (OFD) from one another. This OFD may constitute a static distance and/or may incorporate a positive and/or negative expansion with temperature that complements thermal characteristics of the OMS and/or OFT so as to stabilize the OFD between the OMS and OFT over a predetermined range of temperatures.

### CROSS REFERENCE TO RELATED APPLICATIONS

### Continuation-In-Part Patent Application

This patent application is a Continuation-In-Part patent application (CIP) and incorporates by reference United States Utility patent application for THERMALLY STABILIZED FASTENER SYSTEM AND METHOD by inventors James Jeremy Sean McAllister, and Jay Russell Alan Monroe, Zgarba, filed with the USPTO on 2022 Nov. 5, with Ser. No. 17/981,406, EFS ID 46967901, confirmation number 5389, docket AZTES.0104DIV4, issued as U.S. Pat. No. 12,071,969 on 2024 Aug. 27.

This patent application is a Continuation-In-Part patent application (CIP) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,407, EFS ID 46967904, confirmation number 9791, docket AZTES.0104DIV5, issued as U.S. Pat. No. 12,071,970 on 2024 Aug. 27.

### Divisional Patent Application

United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,407, EFS ID 46967904, confirmation number 9791, docket AZTES.0104DIV5, issued as U.S. Pat. No. 12,071,970 on 2024 Aug. 27 is a Divisional patent application (DIV) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22.

United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,406, EFS ID 46967901, confirmation number 5389, docket AZTES.0104DIV4, issued as U.S. Pat. No. 12,071,969 on 2024 Aug. 27 is a Divisional patent application (DIV) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22.

### U.S. Patent Applications

United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22 is a Continuation-In-Part (CIP) and incorporates by reference United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, issued as U.S. Pat. No. 10,822,670 on 2020 Nov. 3.

United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, issued as U.S. Pat. No. 10,822,670 on 2020 Nov. 3 is a Continuation-In-Part (CIP) patent application 4 and incorporates by reference United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, published on May 12, 2016 as US20160130677A1, issued as U.S. Pat. No. 10,557,182 on 2020 Feb. 11.

United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22, claims benefit under 35 U.S.C. § 120 and incorporates by reference United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, published on May 12, 2016 as US20160130677A1, issued as U.S. Pat. No. 10,557,182 on 2020 Feb. 11.

United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22, claims benefit under 35 U.S.C. § 120 and incorporates by reference United States Utility patent application for LENS ALIGNMENT SYSTEM AND METHOD by inventors James Alan Monroe, David Scott Content, Jeremy Sean McAllister, and Jay Russell Zgarba, filed with the USPTO on Apr. 26, 2018, with Ser. No. 15/963,428, EFSID 32454176, confirmation, docket AZTES.0103, issued as U.S. Pat. No. 11,125,966 on 2021 Sep. 21.

This application claims benefit under 35 U.S.C. § 120 and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22.

### PCT Patent Applications

United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, and published on May 12, 2016 as US20160130677A1, issued as U.S. Pat. No. 10,557,182 on 2020 Feb. 11, is a national stage United States Utility patent application of and incorporates by reference PCT patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 12, 2014, with serial number PCT/US2014/042105, and published on Dec. 18, 2014 as WO2014201239A2.

United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, published on May 12, 2016 as US20160130677A1, issued as U.S. Pat. No. 10,557,182 on 2020 Feb. 11, claims benefit under 35 U.S.C. § 120 and incorporates by reference PCT patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 12, 2014, with serial number PCT/US2014/042105, and published on Dec. 18, 2014 as WO2014201239A2.

### Provisional Patent Applications

PCT patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 12, 2014, with serial number PCT/US2014/042105, and published on Dec. 18, 2014 as WO2014201239A2 claims benefit under 35 U.S.C. § 119 and incorporates by reference United States Provisional patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 14, 2013, with Ser. No. 61/835,289.

United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, issued as U.S. Pat. No. 10,822,670 on 2020 Nov. 3, claims benefit under 35 U.S.C. § 119 and incorporates by reference United States Provisional patent application for CONTROLLED THERMAL COEFFICIENT PRODUCT SYSTEM AND METHOD by inventor James A. Monroe, filed with the USPTO on Jul. 22, 2015, with Ser. No. 62/195,575, EFS ID 22993562, confirmation number 5403, docket AZTES.0101P.

United Utility patent application for LENS ALIGNMENT SYSTEM AND METHOD by inventors James Alan Monroe, David Scott Content, Jeremy Sean McAllister, and Jay Russell Zgarba, filed with the USPTO on Apr. 26, 2018, with Ser. No. 15/963,428, EFSID 32454176, confirmation number 1064, docket AZTES.0103, issued as U.S. Pat. No. 11,125,966 on 2021 Sep. 21 claims benefit under 35 U.S.C. § 119 and incorporates by reference United States Provisional patent application for THERMALLY STABILIZED FASTENER SYSTEM AND METHOD by inventors James Alan Monroe, David Scott Content, Jeremy Sean McAllister, and Jay Russell Zgarba, filed with the USPTO on Apr. 27, 2017, with EFSID 29050356, Ser. No. 62/490,877, confirmation number 8425, docket

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to telescope systems and methods that are thermally stabilized (“athermalized”) over a wide temperature range. Without limitation, the present invention may be applied to situations where a plurality of components in a telescope system must be constructed in a manner so as to maintain specified distances, tensions, or compressions along a common optical axis (COA) when subjected to temperature changes.

### PRIOR ART AND BACKGROUND OF THE INVENTION

Typical telescope systems and methods incorporate one or more mirrors and/or lenses (OML) in conjunction with an optical focal target (OFT) such that light is reflected or refracted by the OML at a specific optical focal distance (OFD) and presented to the OFT as an image for processing and/or analysis. The OML and OFT are retained by a variety of optical separation hardware (OSH) in an optical telescope assembly (OTA) to stabilize the optical focal distance (OFD) between the reflective and/or refractive OML elements and between the OML and OFT such that the OFT is maintained at the OFD to ensure light is focused on the OFT. Each OML component exhibits changes with temperature that shift the OFD of the OTA.

Further, each OSH component has a coefficient of thermal expansion (CTE) associated with its basic material properties and is conventionally constructed of metal to support the mass of the OML and/or OFT. This CTE modulates the OTA due to variations in temperature in which the telescope system operates. This thermal modulation in OTA combined with the thermal changes in OFD results in undesirable blurring of the image presented to the OFT if the CTE of the OSH does not match the change in OFD with temperature changes.

While many exotic methodologies have been proposed to athermally stabilize the OSH and eliminate the OFD modulation over temperature, no simple solution to this problem has been found within the optical arts.

### Long-Felt Industry Need for Thermally Stabilized Telescopes

All metals expand when hot and contract when cold. The positive thermal coefficient experienced by most metals can have a huge impact on telescope applications that see deterioration in the performance, efficiency, and safety of their products due to severe temperature swings and/or vibration. For example, when cooled, aluminum shrinks significantly while a steel bolt shrinks to a lesser extent and as such a fastener joining these materials will loosen with decreasing temperature. When the same joint is heated, the aluminum expands more than the steel bolt and the joint can become over tight stretching or even breaking the bolt. This loosening during thermal cycling and vibration cause fatigue and bolt failure, a long standing major problem in the construction of OML and OFT support/separation structures in telescopes.

The present invention teaches the use of thermally compensating members (TCM) such as tubes, cylinders, and other metallic forms to completely change the way engineers attack the thermal expansion problem and OFD changes in telescopes. Using a simple temperature compensating metal tube/cylinder that expands when cooled can take up the slack in an OTA and stabilize the OFD over temperature. By reacting opposite to other metals, it can enable the OML elements to match the OFD across temperature thereby maintaining focus between the OTA and OFT over severe temperature swings in extreme environments such as space and cryogenic assemblies found in multiple processing environments like liquefied natural gas (LNG) and scientific research labs.

### DEFICIENCIES IN THE PRIOR ART

Prior art thermally stabilized telescope systems typically suffer from the following characteristic deficiencies:
Prior thermally stabilized telescope systems have a coefficient of thermal expansion (CTE) that cannot accurately be controlled.
Prior thermally stabilized telescope systems have a coefficient of thermal expansion (CTE) that cannot be controlled across one or more axes of expansion.
Prior thermally stabilized telescope systems have a coefficient of thermal expansion (CTE) that cannot be tailored to provide a customized expansion coefficient across one or more axes of expansion.
Prior thermally stabilized telescope systems have a coefficient of thermal expansion (CTE) that cannot be tailored to match OFD changes with temperature across one or more axes of expansion.
Prior thermally stabilized telescope systems cannot provide a zero coefficient of thermal expansion (CTE) over one or more axes of expansion.
Prior thermally stabilized telescope systems cannot provide a negative coefficient of thermal expansion (CTE) over one or more axes of expansion.
   To date the prior art has not fully addressed these deficiencies.

### OBJECTIVES OF THE INVENTION

Accordingly, the objectives of the present invention are (among others) to circumvent the deficiencies in the prior art and affect the following objectives:
(1) Provide for a thermally stabilized telescope system/method for producing same that have a coefficient of thermal expansion (CTE) that can accurately be controlled.
(2) Provide for a thermally stabilized telescope system/method for producing same in which the coefficient of thermal expansion (CTE) can be controlled across one or more axes of expansion.
(3) Provide for a thermally stabilized telescope system/method for producing same in which the coefficient of thermal expansion (CTE) can be tailored to provide a customized expansion coefficient across one or more axes of expansion.
(4) Provide for a thermally stabilized telescope system/method for producing the same in which the coefficient of thermal expansion (CTE) can be tailored to match OFD changes with temperature across one or more axes of expansion.
(5) Provide for a thermally stabilized telescope system/method for producing same that can produce a zero coefficient of thermal expansion (CTE) across one or more axes of expansion.
(6) Provide for a thermally stabilized telescope system/method for producing same that can produce a negative coefficient of thermal expansion (CTE) across one or more axes of expansion.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

While all metals expand when hot and contract when cold, the recent development of tailored thermal expansion coefficient (TEC) materials allows the creation of metallic materials that do the opposite: they contract when heated and expand when cooled. This brand-new material property enables the creation of tubular separators that compensate for the natural expansion and contraction of other materials being separated and thus the creation of thermally stabilized telescopes as described herein.

The present invention generally addresses the need for thermally stabilized telescope systems having a known coefficient of thermal expansion (CTE) in the following manner. The disclosed system/method separates an optical mirror source (OMS) and an optical focal target (OFT) via a series connection of a first metering tube (FMT) and a second metering tube (SMT) that have been selected to have complementary thermal expansion characteristics so as to keep the OMS and OFT at a predetermined distance from one another. In this manner the OFD associated with the OMS and OFT is maintained at a constant distance over a wide temperature range.

Details regarding the tailored CTE metallic material product (MMP) is disclosed within United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, and other patents/patent applications incorporated herein.

### BRIEF DESCRIPTION OF THE DRAWINGS

For a fuller understanding of the advantages provided by the invention, reference should be made to the following detailed description together with the accompanying drawings wherein:

FIG. 1 illustrates an optical telescope assembly (OTA) diagram describing a preferred exemplary system embodiment of the present invention;

FIG. 2 illustrates a flowchart illustrating a preferred exemplary method embodiment of the present invention;

FIG. 3 illustrates a front view of a preferred exemplary invention embodiment;

FIG. 4 illustrates a rear view of a preferred exemplary invention embodiment;

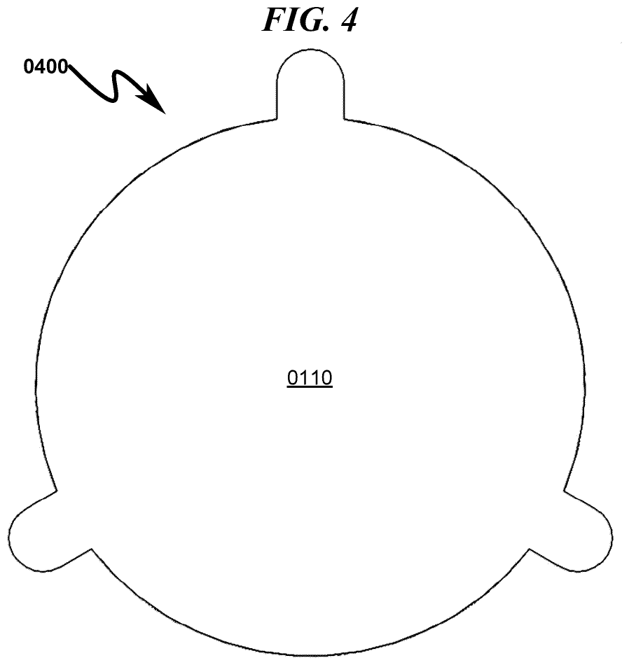

FIG. 5 illustrates a left side view of a preferred exemplary invention embodiment;

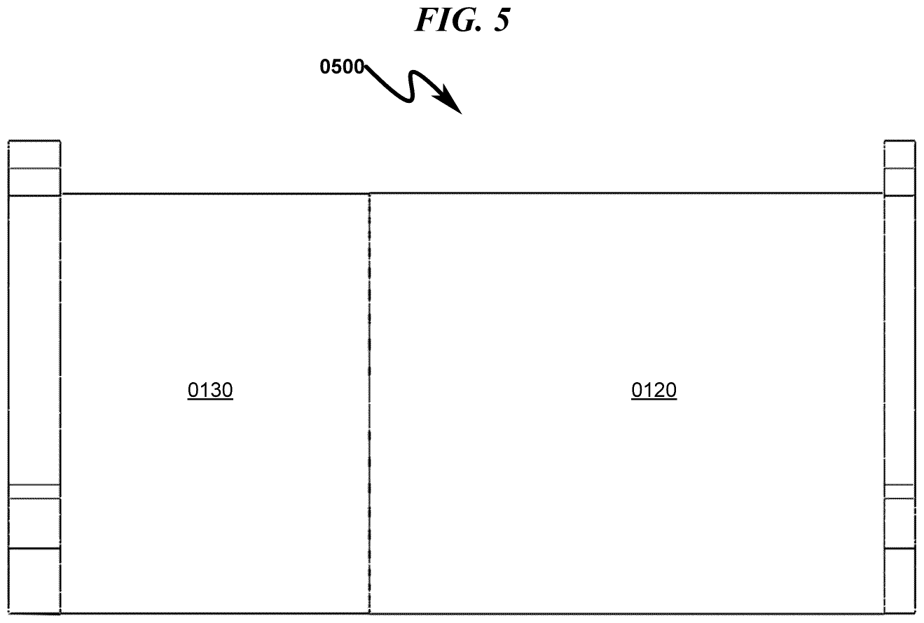

FIG. 6 illustrates a right side view of a preferred exemplary invention embodiment;

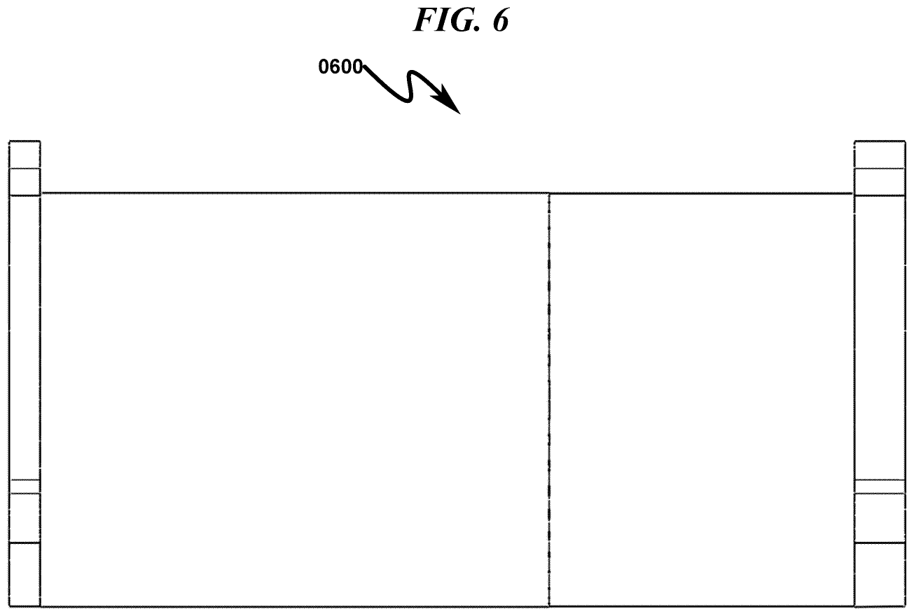

FIG. 7 illustrates a top view of a preferred exemplary invention embodiment;

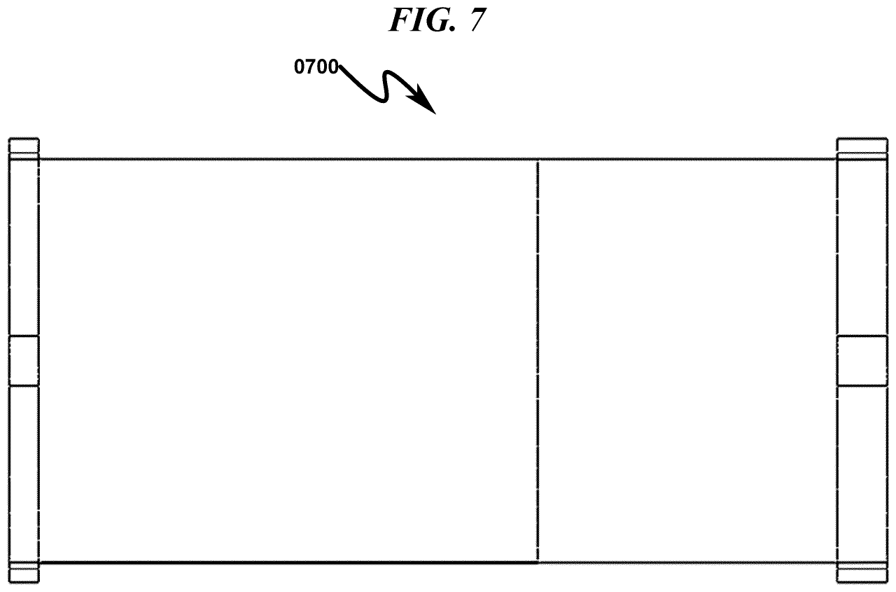

FIG. 8 illustrates a bottom view of a preferred exemplary invention embodiment;

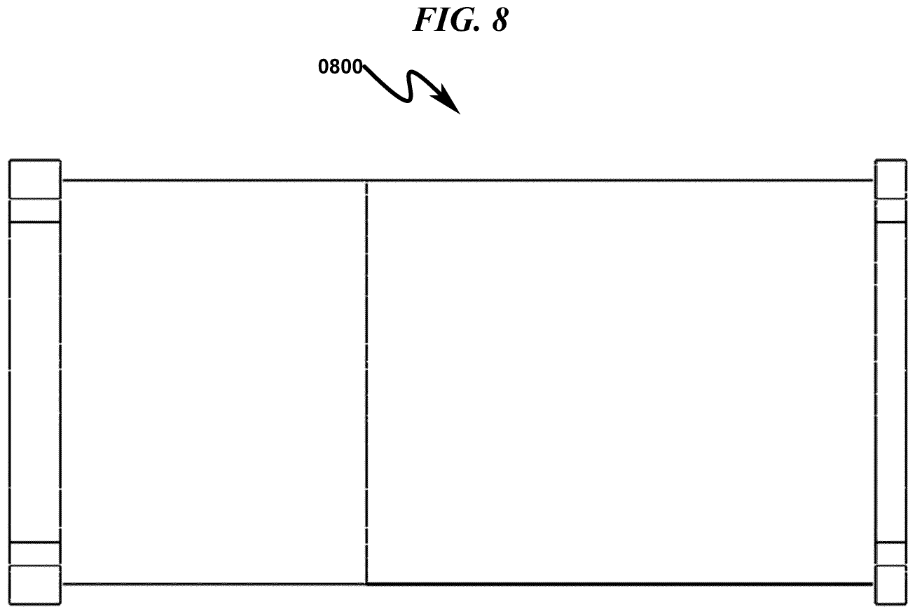

FIG. 9 illustrates a top right front perspective view of a preferred exemplary invention embodiment;

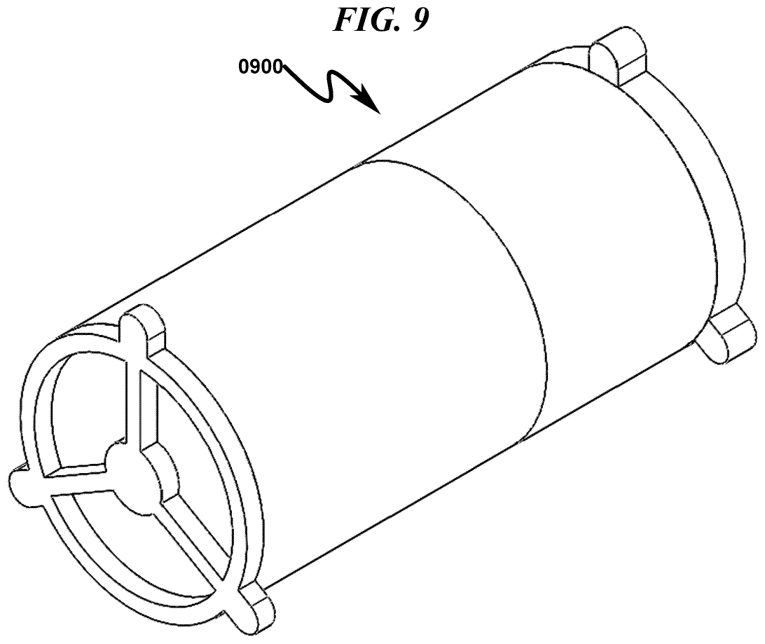

FIG. 10 illustrates a top right rear perspective view of a preferred exemplary invention embodiment;

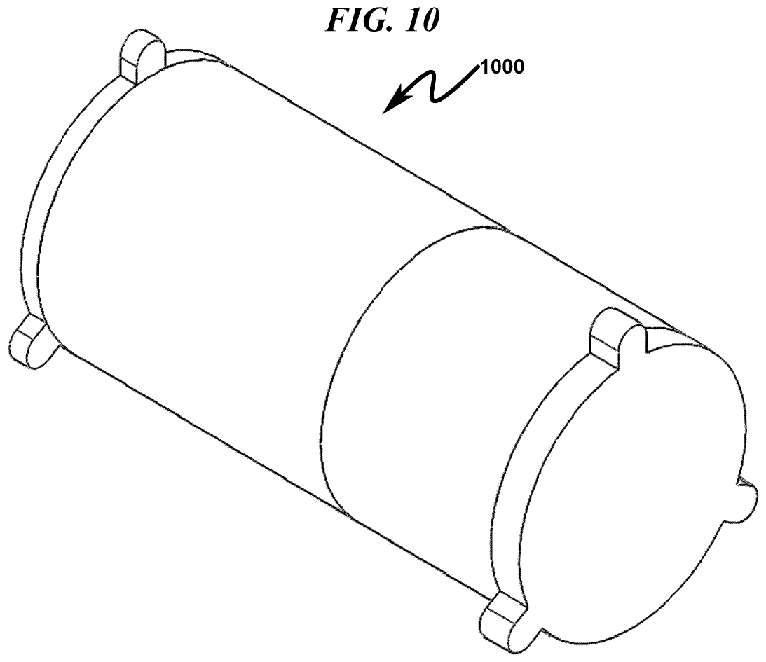

FIG. 11 illustrates a top left rear perspective view of a preferred exemplary invention embodiment;

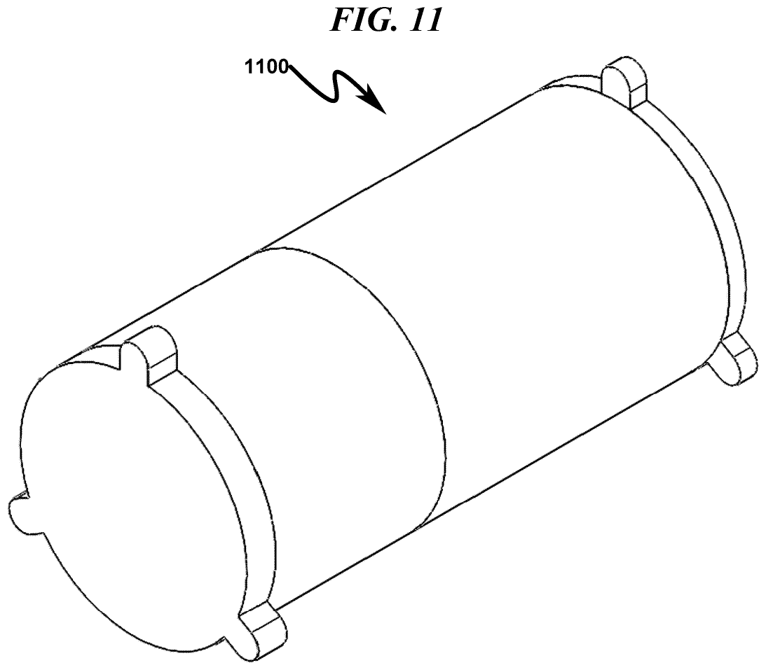

FIG. 12 illustrates a top left front perspective view of a preferred exemplary invention embodiment;

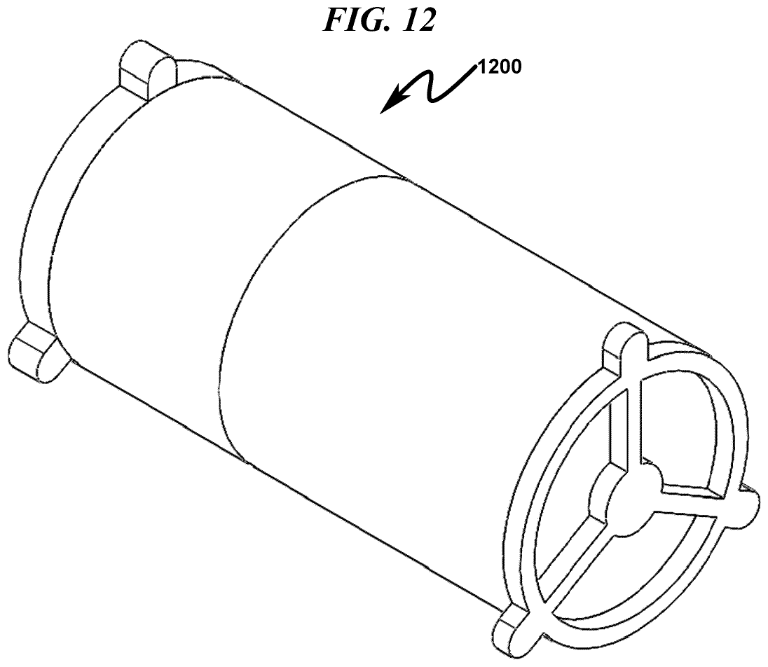

FIG. 13 illustrates a bottom right front perspective view of a preferred exemplary invention embodiment;

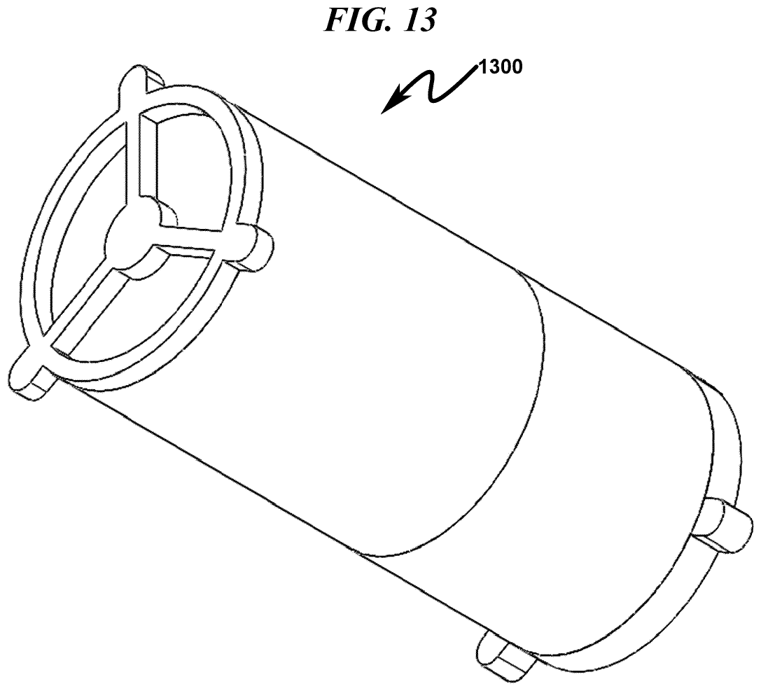

FIG. 14 illustrates a bottom right rear perspective view of a preferred exemplary invention embodiment;

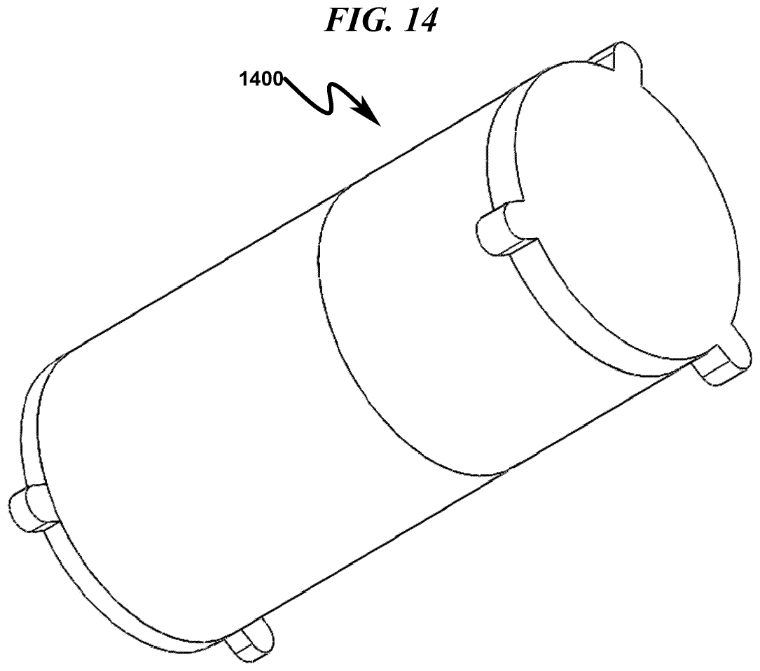

FIG. 15 illustrates a bottom left rear perspective view of a preferred exemplary invention embodiment;

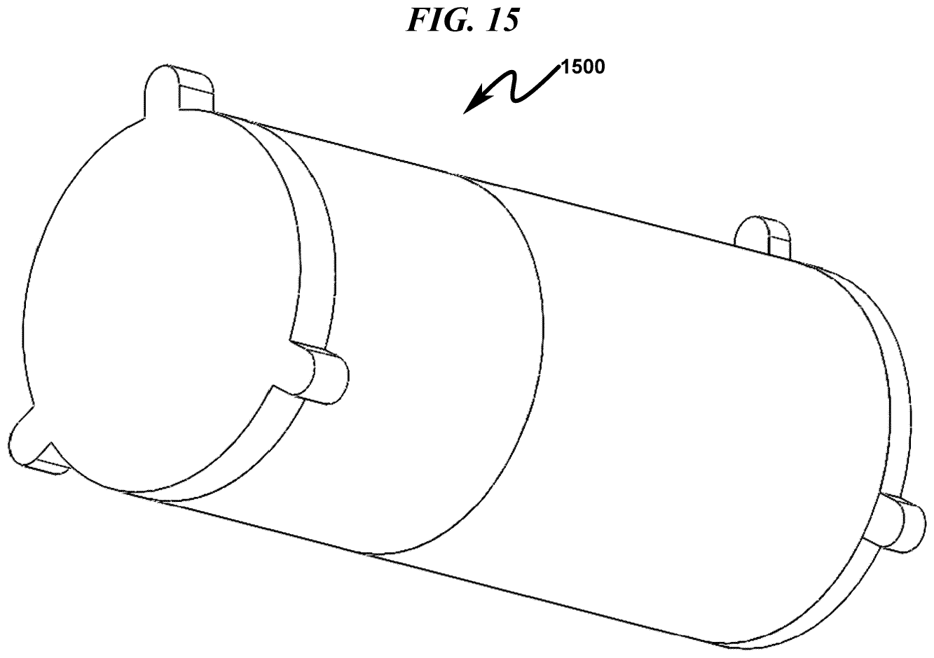

FIG. 16 illustrates a bottom left front perspective view of a preferred exemplary invention embodiment;

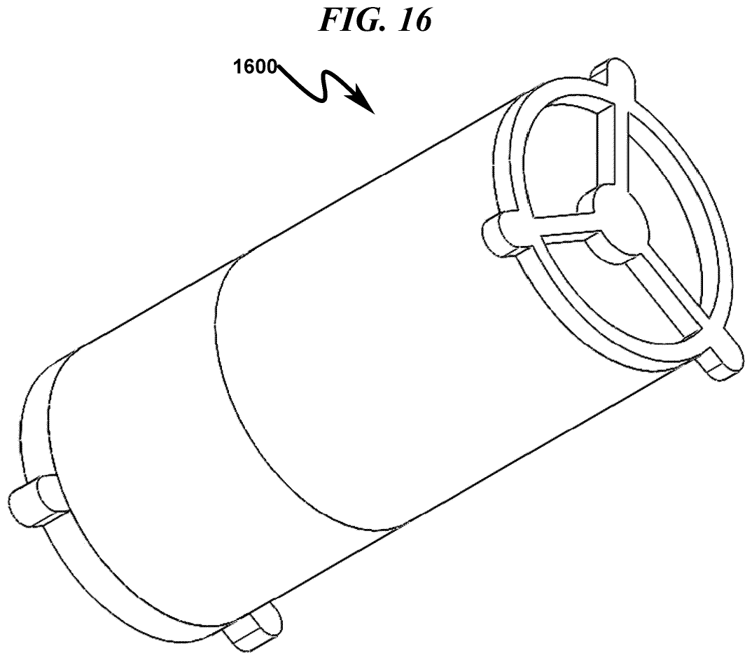

FIG. 17 illustrates a top right front perspective right section view of a preferred exemplary invention embodiment;

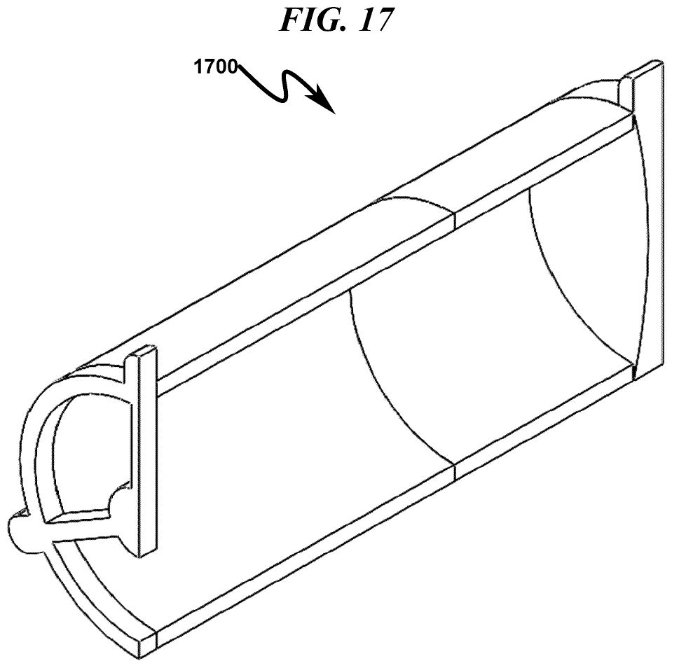

FIG. 18 illustrates a top right rear perspective right section view of a preferred exemplary invention embodiment;

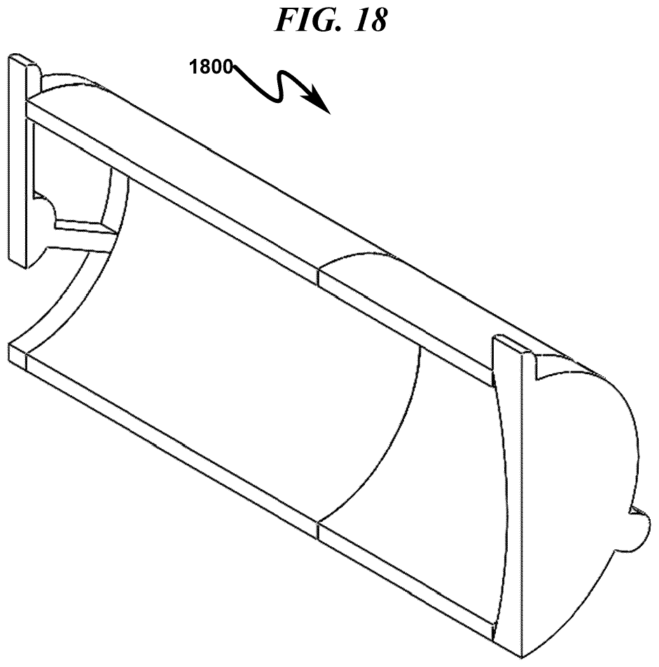

FIG. 19 illustrates a bottom right front perspective right section view of a preferred exemplary invention embodiment;

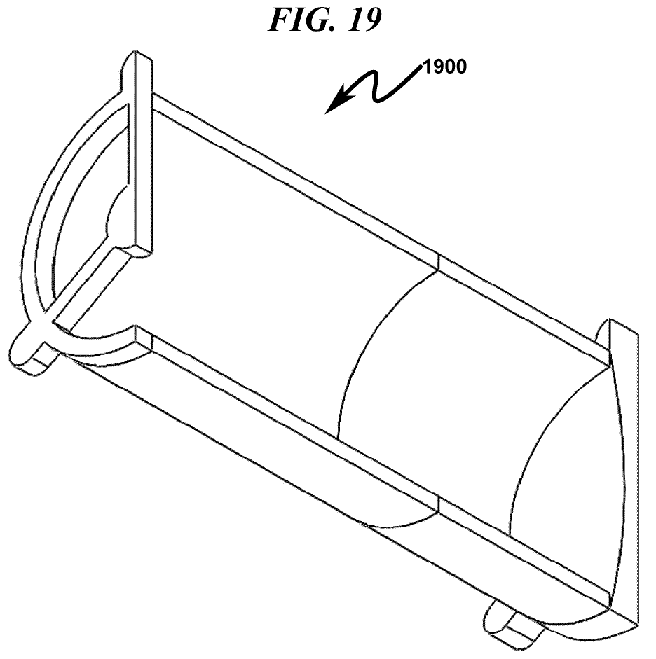

FIG. 20 illustrates a bottom right rear perspective right section view of a preferred exemplary invention embodiment;

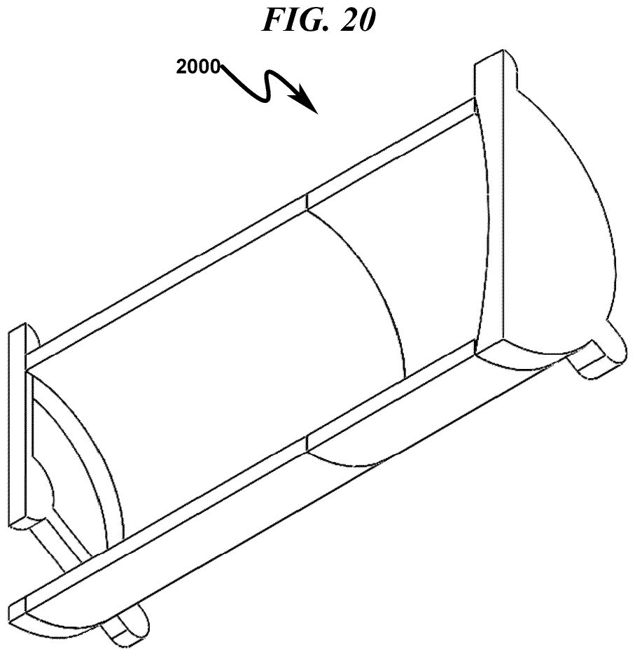

FIG. 21 illustrates a top right front perspective top section view of a preferred exemplary invention embodiment;

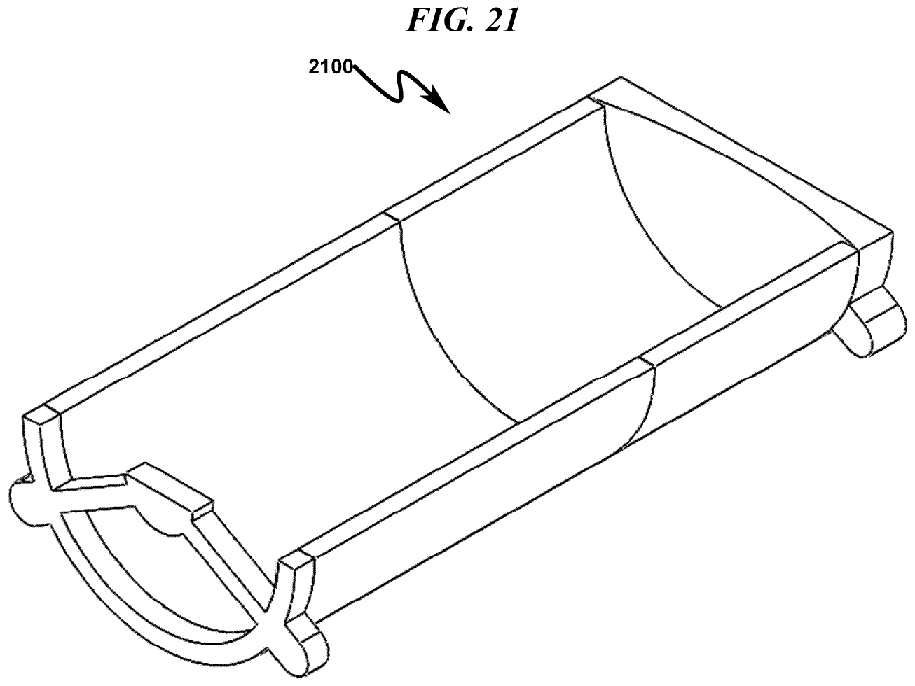

FIG. 22 illustrates a top right rear perspective top section view of a preferred exemplary invention embodiment;

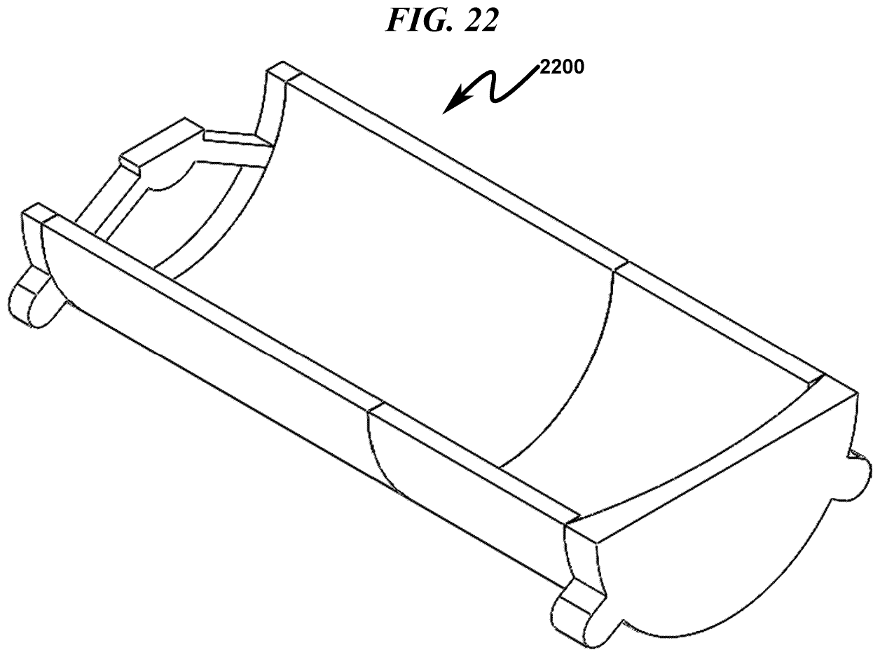

FIG. 23 illustrates a top left rear perspective top section view of a preferred exemplary invention embodiment;

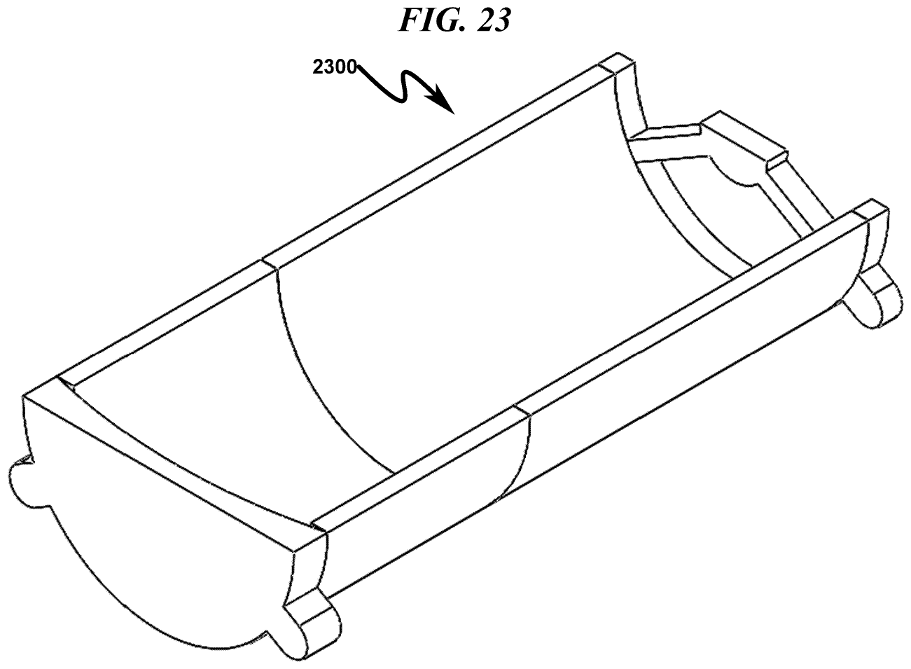

FIG. 24 illustrates a top left front perspective top section view of a preferred exemplary invention embodiment;

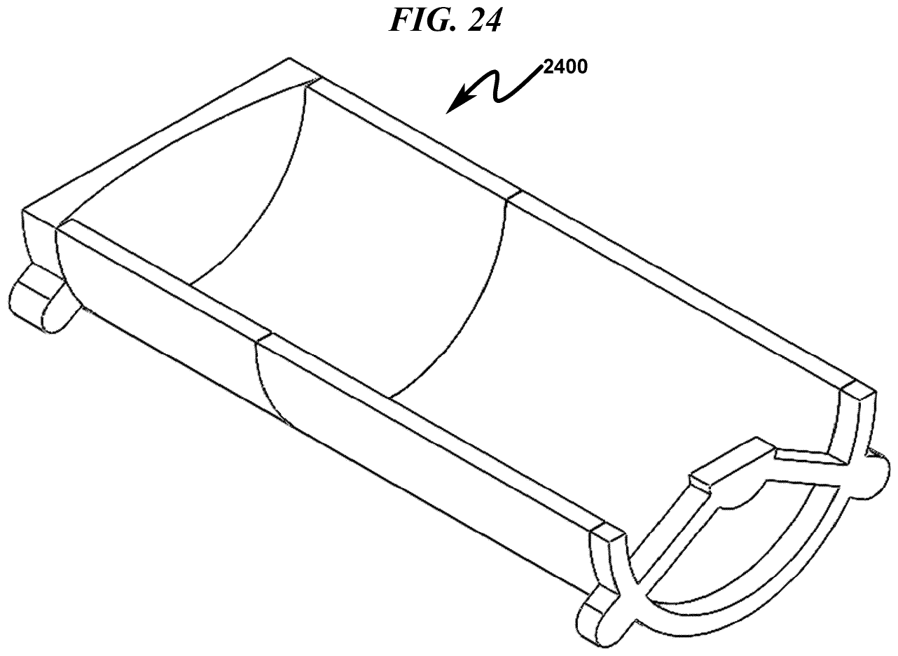

FIG. 25 illustrates a top right front perspective assembly view of a preferred exemplary invention embodiment;

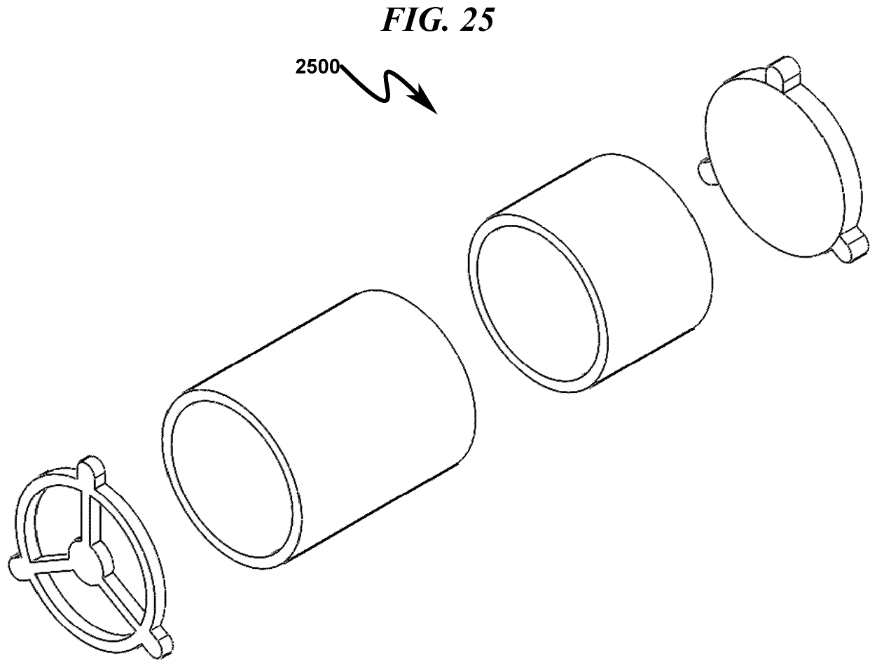

FIG. 26 illustrates a top right rear perspective assembly view of a preferred exemplary invention embodiment;

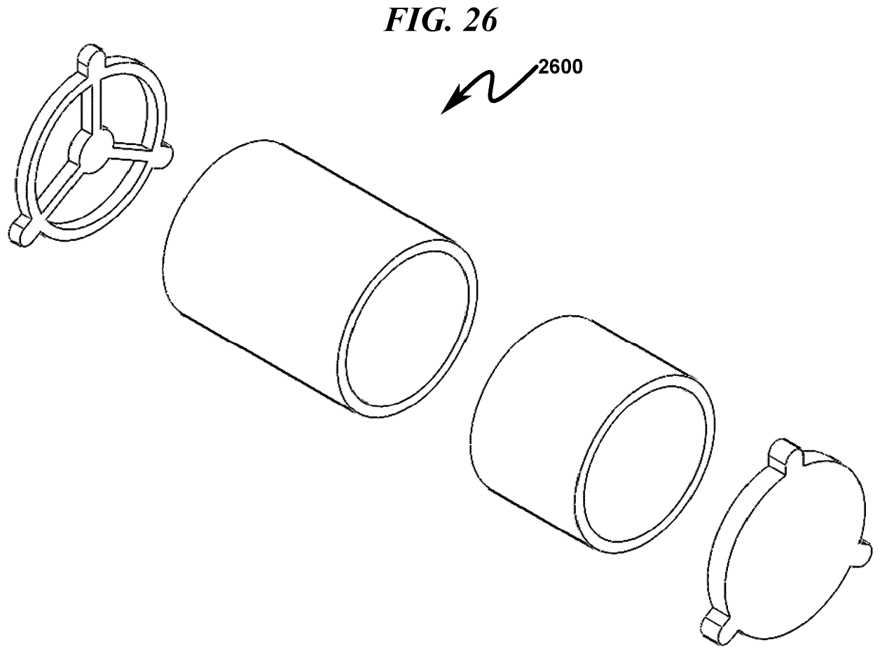

FIG. 27 illustrates a top left rear perspective assembly view of a preferred exemplary invention embodiment;

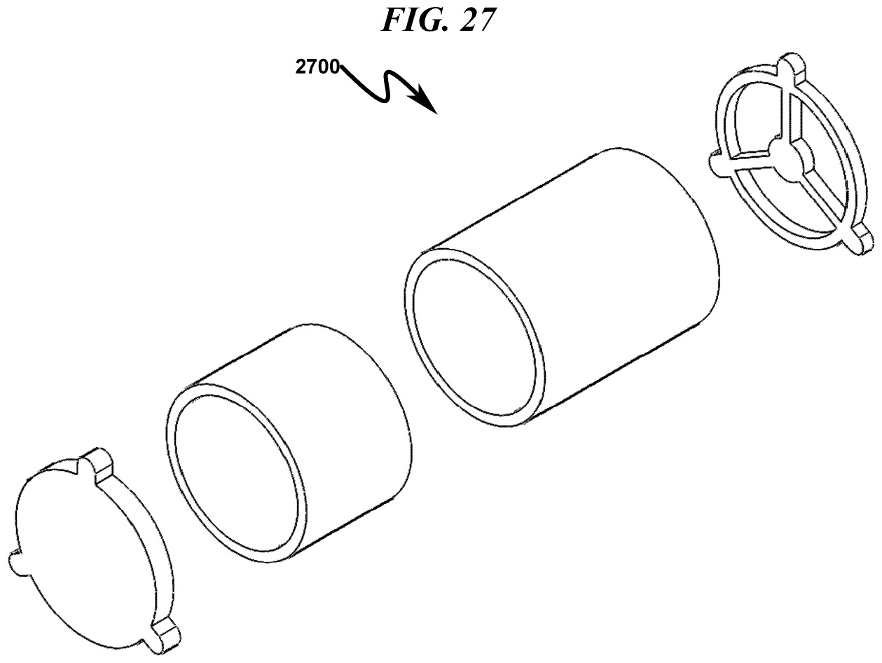

FIG. 28 illustrates a top left front perspective assembly view of a preferred exemplary invention embodiment;

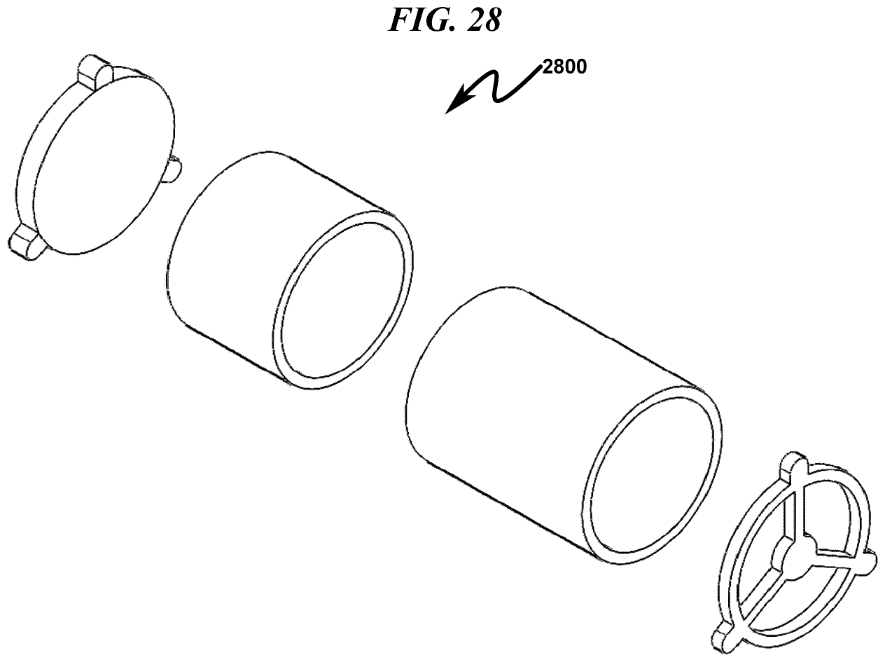

FIG. 29 illustrates a top right front perspective right section assembly view of a preferred exemplary invention embodiment;

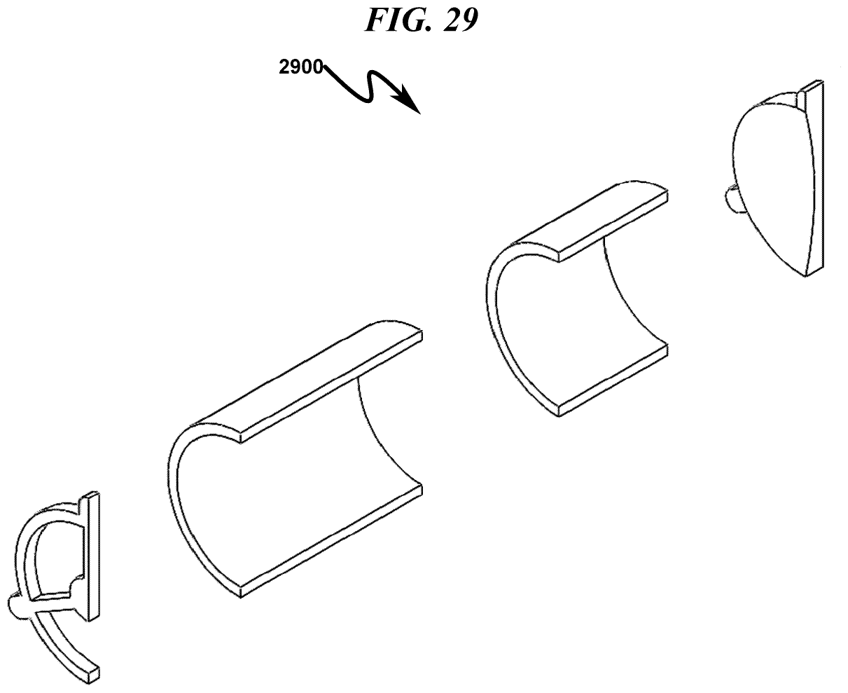

FIG. 30 illustrates a top right rear perspective right section assembly view of a preferred exemplary invention embodiment;

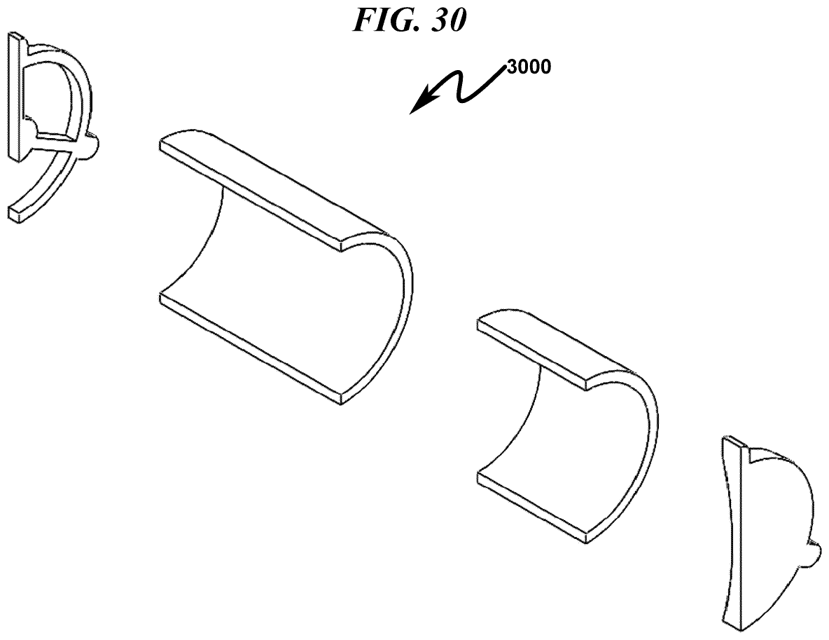

FIG. 31 illustrates a top right front perspective top section assembly view of a preferred exemplary invention embodiment;

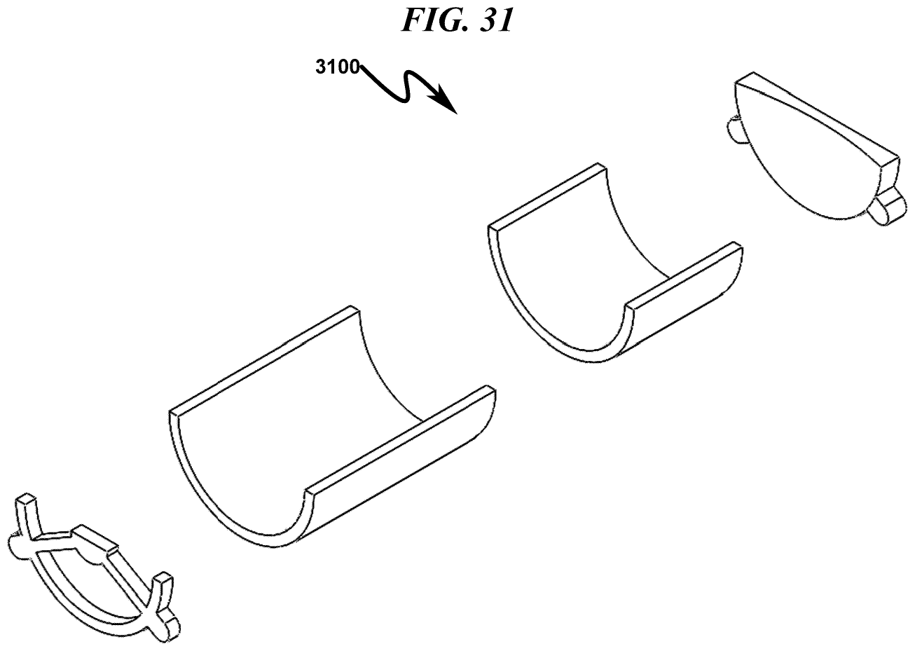

FIG. 32 illustrates a top right rear perspective top section assembly view of a preferred exemplary invention embodiment;

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a TELESCOPE SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Tailored Thermal Expansion Coefficient (TEC) Defined

The term “tailored thermal expansion coefficient (TEC)” as used herein to describe the formulation and manufacture of the temperature compensating member (TCM) refers to the methods and products of material manufacture described in United States Utility patent applications that are included by reference in this patent application.

These patent applications teach the fabrication of metallic materials that have a range of tailored thermal expansion coefficients that are outside of those available using conventional A286, INCONEL 903, WASPALOY, Invar, or other materials known to those of skill in the art as described in the prior art included-by-reference document SAE AIR1754B Aerospace Information Report for “Washer, Thermal Compensating, Metric Series” from SAE International (www.sae.org), Issued 1981-12, Revised 2001-10, Reaffirmed 2012-10, Stabilized 2019-02, Superseding AIR1754A. Since this document was stabilized in February 2019 (38 years after first issuance) as of this date the document indicates that were no known methodologies of achieving thermally stabilized fasteners or separators other than that provided in this SAE standard. As such, the present invention as described herein is novel with respect to the disclosure scope of this SAE document.

### System Overview (0100)

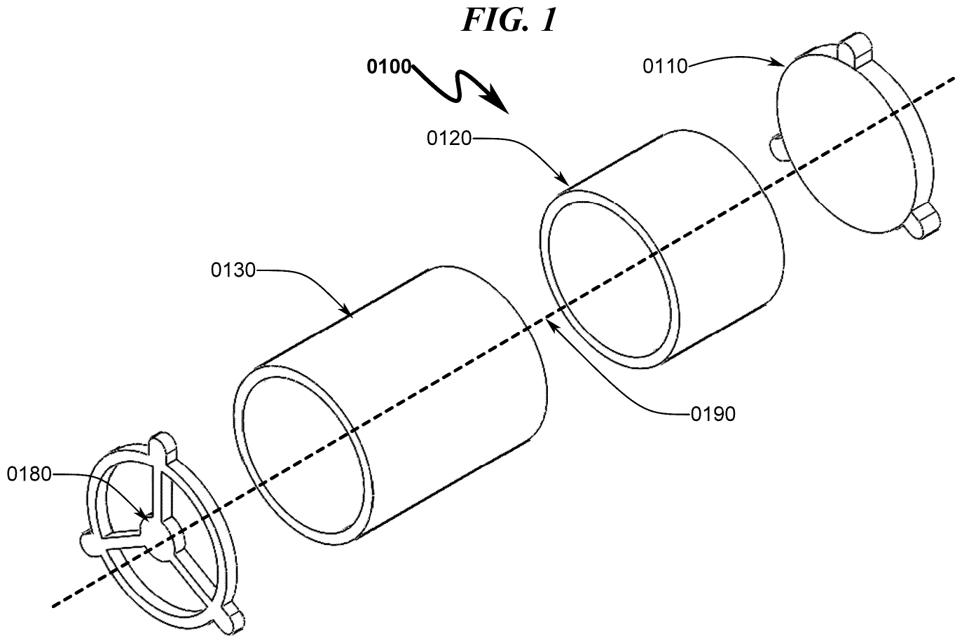

FIG. 1 (0100)) depicts an assembly view of a preferred exemplary invention embodiment illustrating a series tailored athermally stabilized optical (STASO) telescope system. The disclosed system separates an optical mirror source (OMS) (0110) and an optical focal target (OFT) (0180) via a series connection of a first metering tube (FMT) (0120) and a second metering tube (SMT) (0130) that have been selected to have complementary thermal expansion characteristics so as to keep the OMS (0110) and OFT (0180) at a predetermined optical focal distance (OFD) from one another along a common optical axis (COA) (0190). This OFD may constitute a static distance and/or may incorporate a positive and/or negative expansion with temperature that complements the thermal expansion characteristics of the OMS (0110) and/or OFT (0180) so as to stabilize the OFD between the OMS (0110) and OFT (0180) over a predetermined range of temperatures.

This system permits a predetermined focal distance (PFD) between a mirror reference surface (MRS) perpendicular to an optical axis of the OMS and a focal reference plane (FRP) aligned to an optical axis of the OFT to be maintained across a wide range of temperatures.

### Method Overview (0200)

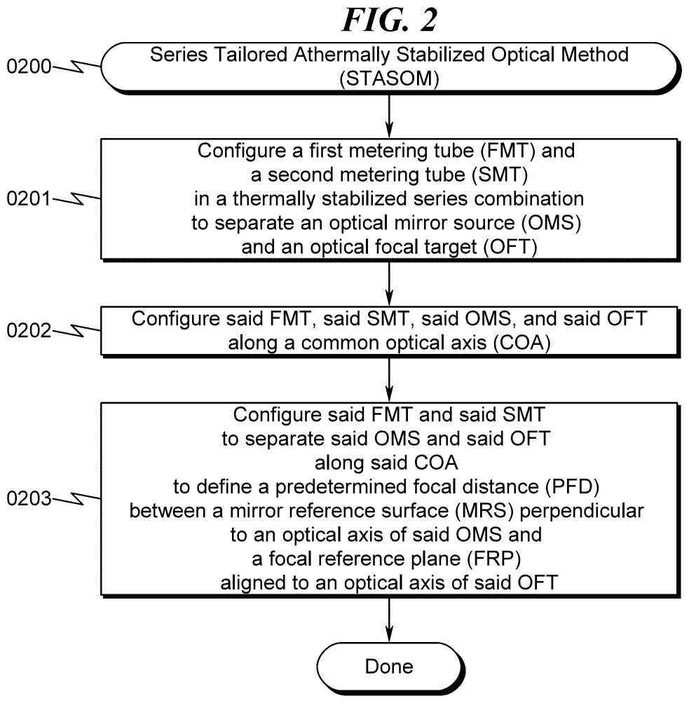

The present invention may implement a method in which a thermally stabilized telescope is designed using TEC materials fabricated to compensate a tubular separator combination. In this thermally stabilized telescope methodology, as generally depicted in FIG. 2 (0200), the present invention may be broadly generalized as a series tailored athermally stabilized optical (STASO) telescope method comprising:
(1) configuring a first metering tube (FMT) and a second metering tube (SMT) in series combination to separate an optical mirror source (OMS) and an optical focal target (OFT) (0201);
(2) configuring the FMT, the SMT, the OMS, and the OFT along a common optical axis (COA) (0202); and
(3) configuring the FMT and the SMT to separate the OMS and the OFT along the COA to define a predetermined focal distance (PFD) between a mirror reference surface (MRS) perpendicular to an optical axis of the OMS and a focal reference plane (FRP) aligned to an optical axis of the OFT (0203);
wherein:
the FMT comprises a material having a first thermal expansion (FTE) coefficient;
the SMT comprises a material having a second thermal expansion (STE) coefficient;
the FMT is constructed from a thermalized metallic material (TMM) selected to produce in combination with the SMT a thermally controlled optical (TCO) variation in the PFD;
the TMM is constructed by deforming a metallic material by applying tension in a first direction;
the TMM, subsequent to the deformation, exhibits a first thermal expansion characteristic having a coefficient of thermal expansion within a predetermined range;
the coefficient of thermal expansion is in at least the first direction;
the TMM, subsequent to the deformation, exhibits a second thermal expansion characteristic in a second direction; and
wherein the TMM comprises a material selected from a group consisting of:
   a material characterized by a general formula Ti_{100-A}X_{A}, wherein X is at least one of Ni, Nb, Mo, Ta, Pd, Pt, or combinations thereof, and A is in a range from 0 to 75 atomic percent composition;
   a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
   a material characterized by a general formula Ti_{100-A-B}Nb_{A}X_{B}, wherein X is at least one of Al, Sn, Ta, Hf, Zr, Al, Au, Pt, Fe, Co, Cr, Mo, V, O, or combinations thereof, and A is in a range from 0 to 55 atomic percent composition, and B is in a range from 0 to 75 atomic percent composition such that A plus B is less than 100; and
   a material characterized by a general formula Ti_{100-A-B}Ta_{A}X_{B}, wherein X is at least one of Al, Sn, Nb, Zr, Mo, Al, Au, Pt, Fe, Co, Cr, Hf, V, O, or combinations thereof, and A is in a range from 0 to 55 atomic percent composition, and B is in a range from 0 to 75 atomic percent composition such that A plus B is less than 100.
      This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Exemplary TCM Materials

The TCM candidate materials may be selected from a list of materials that have been discovered to exhibit the required CTE when combined as indicated below:
Ti_{100-A}X_{A} (X=at least one of Ni, Nb, Mo, Ta, Pd, Pt, or combinations thereof) (A=0 to 75 atomic percent composition), Ti_{100-A-B}Ni_{A}X_{B} (X=at least one of Pd, Hf, Zr, Al, Pt, Au, Fe, Co, Cr, Mo, V, O or combinations thereof) (A=0 to 55 atomic percent composition and B=0 to 75 atomic percent composition such that A+B<100), Ti_{100-A-B}Nb_{A}X_{B} (X=at least one of Al, Sn, Ta, Hf, Zr, Al, Au, Pt, Fe, Co, Cr, Mo, V, O, or combinations thereof) (A=0 to 55 atomic percent composition and B=0 to 75 atomic percent composition such that A+B<100), Ti_{100-A-B}Ta_{A}X_{B} (X=at least one of Al, Sn, Nb, Zr, Mo, Al, Au, Pt, Fe, Co, Cr, Hf, V, O, or combinations thereof) (A=0 to 55 atomic percent composition and B=0 to 75 atomic percent composition such that A+B<100), Ni_{100-A-B}Mn_{A}X_{B} (X=at least one of Ga, In, Sn, Al, Sb, Co, or combinations thereof) (A=0 to 50 atomic percent composition and B=0 to 50 atomic percent composition such that A+B<100), Ni_{100-A-B-C}Mn_{A}Co_{B}X_{C} (X=at least one of Ga, In, Sn, Al, Sb, or combinations thereof) (A=0 to 50 atomic percent composition, B=0 to 50 atomic percent composition, and C=0 to 50 atomic percent composition such that A+B+C<100), Ni_{100-A-B}Fe_{A}Ga_{B} (A=0 to 50 atomic percent composition and B=0 to 50 atomic percent composition such that A+B<100), Cu_{100-A}X_{A} (X=at least one of Zn, Ni, Mn, Al, Be, or combinations thereof) (A=0 to 75 atomic percent composition), Cu_{100-A-B}Al_{A}X_{B} (X=at least one of Zn, Ni, Mn, Be, or combinations thereof) (A=0 to 50 atomic percent composition and B=0 to 50 atomic percent composition such that A+B<100), Cu_{100-A-B-C}Mn_{A}Al_{B}X_{C} (X=at least one of Zn, Ni, Be, or combinations thereof) (A=0 to 50 atomic percent composition, B=0 to 50 atomic percent composition, and C=0 to 50 atomic percent composition such that A+B+C<100), Co_{100-A-B}Ni_{A}X_{B} (X=at least one of Al, Ga, Sn, Sb, In, or combinations thereof) (A=0 to 50 atomic percent composition and B=0 to 50 atomic percent composition such that A+B<100), Fe_{100-A-B}Mn_{A}X_{B} (X=at least one of Ga, Ni, Co, Al, Ta, Si, or combinations thereof) (A=0 to 50 atomic percent composition and B=0 to 50 atomic percent composition such that A+B<100), Fe_{100-A-B}Ni_{A}X_{B} (X=at least one of Ga, Mn, Co, Al, Ta, Si, or combinations thereof) (A=0 to 50 atomic percent composition and B=0 to 50 atomic percent composition such that A+B<100), Fe_{100-A-B-C}Ni_{A}Co_{B}Al_{C}X_{D} (X=at least one of Ti, Ta, Nb, Cr, W or combinations thereof) (A=0 to 50 atomic percent composition, B=0 to 50 atomic percent composition, C=0 to 50 atomic percent composition, and D=0 to 50 atomic percent composition such that A+B+C+D<100), Fe_{100-A-B-C}Ni_{A}Co_{B}Ti_{C}X_{D} (X=at least one of Al, Ta, Nb, Cr, W or combinations thereof) (A=0 to 50 atomic percent composition, B=0 to 50 atomic percent composition, C=0 to 50 atomic percent composition, and D=0 to 50 atomic percent composition such that A+B+C+D<100), and combinations thereof that exhibit martensitic transformation.
NiTi, NiTiPd, NiTiHf, NiTiPt, NiTiAu, NiTiZr, NiMn, NiMnGa, NiMnSn, NiMnIn, NiMnAl, NiMnSb, NiCoMn, NiCoMnGa, NiCoMnSn, NiCoMnAl, NiCoMnIn, NiCoMnSb, NiFeGa, Mn FeGa, TiNb, TiMo, TiNbAl, TiNbSn, TiNbTa, TiNbZr, TiNbO, CuMnAlNi, CuMnAl, CuZnAl, CuNiAl, CuAlBe, CoNi, CoNiAl, CoNiGa, FeMn, FeMnGa, FeMnNi, FeMnCo, FeMnAl, FeMnTa, FeMnNiAl, FeNiCoAl, FeNiCoAlTa, FeNiCoAlTi, FeNiCoAlNb, FeNiCoAlW, FeNiCoAlCr, FeMnSi, FeNiCo, FeNiCoTi, as well as derivations and combinations thereof that exhibit martensitic transformation.

Other TCM materials may be utilized as described in United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation serial number 5258, docket TAMUS CIP, 3809 and other patents/patent applications incorporated herein.

### Exemplary System Construction (0300)-(3200)

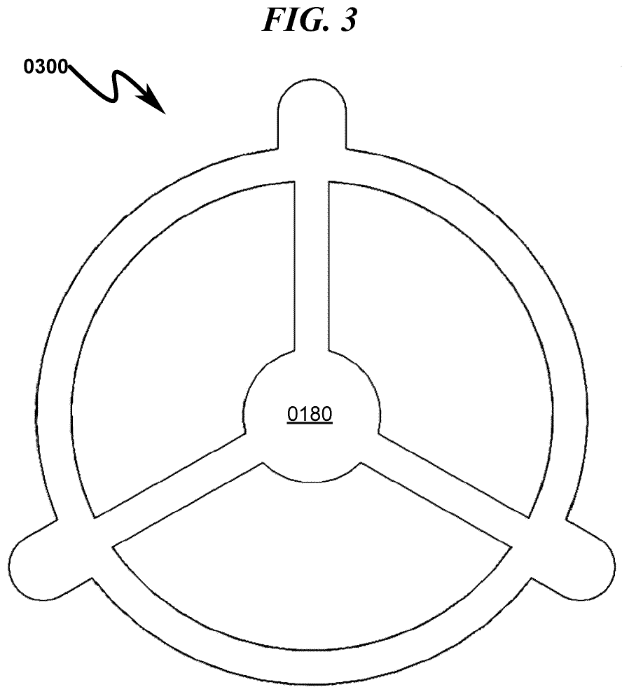

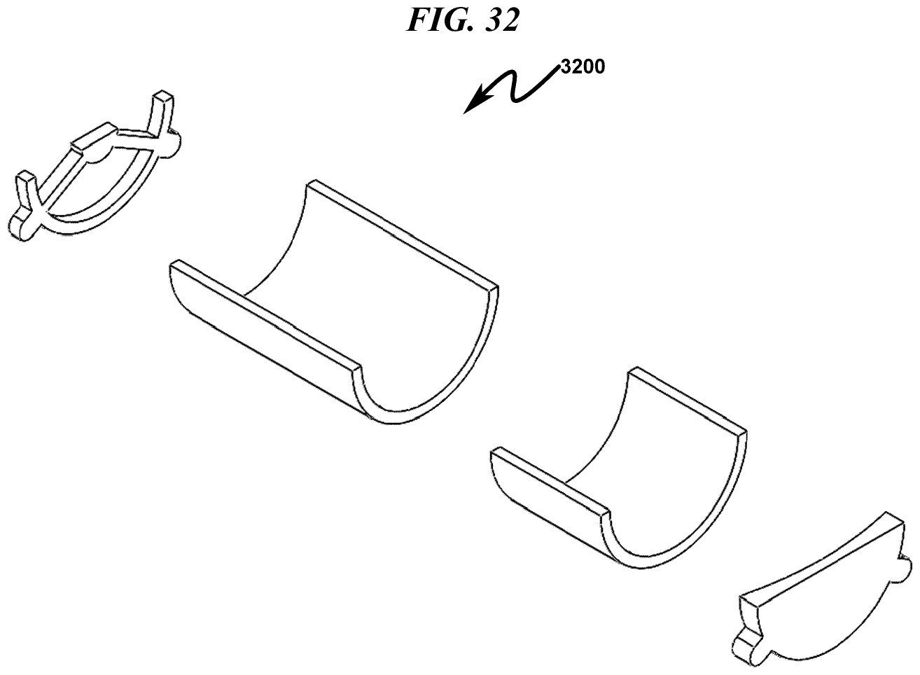

The present invention system in a preferred exemplary embodiment is generally illustrated in the various views of FIG. 3 (0300)-FIG. 32 (3200). One skilled in the art may recognize that this construction is only exemplary of many configurations in which the focal distance between the optical mirror source (OMS) and optical focal target (OFT) is thermally astabilized via a series connection of a first metering tube (FMT) and a second metering tube (SMT).

### System Summary

The present invention system may be broadly generalized as a series tailored athermally stabilized optical (STASO) telescope system comprising:
(a) optical mirror source (OMS);
(b) optical focal target (OFT);
(c) first metering tube (FMT); and
(d) second metering tube (SMT);
wherein:
the OMS comprises a mirror reference surface (MRS) perpendicular to an optical axis (OAX) of the OMS;
the OFT comprises a focal reference plane (FRP) aligned to the OAX the OFT;
the FMT comprises a material having a first thermal expansion (FTE) coefficient;
the SMT comprises a material having a second thermal expansion (STE) coefficient;
the FMT and the SMT are aligned along a common optical axis (COA);
the FMT and the SMT are configured to align the OMS and OFT along the COA;
the FMT and the SMT are configured to separate the OMS and the OFT along the COA and define a predetermined focal distance (PFD) between the MRS and the FRP;
the FMT is a constructed from thermalized metallic material (TMM) selected to produce in combination with the SMT a thermally controlled optical (TCO) variation in the PFD;
the TMM is constructed by deforming a metallic material by applying tension in a first direction;
the TMM, subsequent to the deformation, exhibits a first thermal expansion characteristic having a coefficient of thermal expansion within a predetermined range;
the coefficient of thermal expansion is in at least the first direction;
the TMM, subsequent to the deformation, exhibits a second thermal expansion characteristic in a second direction; and
wherein the TMM comprises a material selected from a group consisting of:
   (1) a material characterized by a general formula Ti_{100-A}X_{A}, wherein X is at least one of Ni, Nb, Mo, Ta, Pd, Pt, or combinations thereof, and A is in a range from 0 to 75 atomic percent composition;
   (2) a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
   (3) a material characterized by a general formula Ti_{100-A-B}Nb_{A}X_{B}, wherein X is at least one of Al, Sn, Ta, Hf, Zr, Al, Au, Pt, Fe, Co, Cr, Mo, V, O, or combinations thereof, and A is in a range from 0 to 55 atomic percent composition, and B is in a range from 0 to 75 atomic percent composition such that A plus B is less than 100; and
   (4) a material characterized by a general formula Ti_{100-A-B}Ta_{A}X_{B}, wherein X is at least one of Al, Sn, Nb, Zr, Mo, Al, Au, Pt, Fe, Co, Cr, Hf, V, O, or combinations thereof, and A is in a range from 0 to 55 atomic percent composition, and B is in a range from 0 to 75 atomic percent composition such that A plus B is less than 100.
      This general system summary may be augmented by the various elements described herein to produce a wide variety of invention embodiments consistent with this overall design description.

### Method Summary

A preferred exemplary embodiment of the present invention method may be broadly generalized as a series tailored athermally stabilized optical (STASO) telescope method comprising:
(1) configuring a first metering tube (FMT) and a second metering tube (SMT) in series combination to separate an optical mirror source (OMS) and an optical focal target (OFT);
(2) configuring the FMT, the SMT, the OMS, and the OFT along a common optical axis (COA); and
(3) configuring the FMT, the SMT to separate the OMS and the OFT along the COA to define a predetermined focal distance (PFD) between a mirror reference surface (MRS) perpendicular to an optical axis of the OMS and a focal reference plane (FRP) aligned to an optical axis of the OFT;
wherein:
the FMT comprises a material having a first thermal expansion (FTE) coefficient;
the SMT comprises a material having a second thermal expansion (STE) coefficient;
the FMT is constructed thermalized from a metallic material (TMM) selected to produce in combination with the SMT a thermally controlled optical (TCO) variation in the PFD;
the TMM is constructed by deforming a metallic material by applying tension in a first direction;
the TMM, subsequent to the deformation, exhibits a first thermal expansion characteristic having a coefficient of thermal expansion within a predetermined range;
the coefficient of thermal expansion is in at least the first direction; and
the TMM, subsequent to the deformation, exhibits a second thermal expansion characteristic in a second direction; and
wherein the TMM comprises a material selected from a group consisting of:
   a material characterized by a general formula Ti_{100-A}X_{A}, wherein X is at least one of Ni, Nb, Mo, Ta, Pd, Pt, or combinations thereof, and A is in a range from 0 to 75 atomic percent composition;
   a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
   a material characterized by a general formula Ti_{100-A-B}Nb_{A}X_{B}, wherein X is at least one of Al, Sn, Ta, Hf, Zr, Al, Au, Pt, Fe, Co, Cr, Mo, V, O, or combinations thereof, and A is in a range from 0 to 55 atomic percent composition, and B is in a range from 0 to 75 atomic percent composition such that A plus B is less than 100; and
   a material characterized by a general formula Ti_{100-A-B}Ta_{A}X_{B}, wherein X is at least one of Al, Sn, Nb, Zr, Mo, Al, Au, Pt, Fe, Co, Cr, Hf, V, O, or combinations thereof, and A is in a range from 0 to 55 atomic percent composition, and B is in a range from 0 to 75 atomic percent composition such that A plus B is less than 100.
      This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the deformation is achieved by at least one of:
   (1) hot-rolling;
   (2) cold-rolling;
   (3) plane strain compression;
   (4) bi-axial tension;
   (5) conformal processing;
   (6) bending;
   (7) drawing;
   (8) wire-drawing;
   (9) swaging;
   (10) extrusion;
   (11) equal channel angular extrusion;
   (12) precipitation heat treatment under stress;
   (13) annealing;
   (14) sintering;
   (15) monotonic tension processing;
   (16) monotonic compression processing;
   (17) monotonic torsion processing;
   (18) cyclic thermal training under stress; and
   (19) combinations thereof.
An embodiment wherein the predetermined range of the coefficient of thermal expansion ranges from −150×10⁻⁶K⁻¹ to +500×10⁻⁶K⁻¹.
An embodiment wherein the deforming of the metallic material further comprises texturing the metallic material in a direction comprising at least one of a [111], a [100], or a [001] direction.
An embodiment wherein the TMM comprises a material having a negative thermal expansion (NTE) coefficient.
An embodiment wherein:
   the deforming the TMM comprises applying tension in at least one direction; and
   the second thermal expansion characteristic subsequent to the deformation is in at least one direction.
An embodiment wherein:
   the deforming the TMM comprises applying compression in first direction;
   the second thermal expansion characteristic subsequent to the deformation is in at least one predetermined direction; and
   the at least one predetermined direction is perpendicular to the first direction.
An embodiment wherein:
   the deforming the TMM comprises applying shear in the first direction;
   the second thermal expansion characteristic subsequent to deformation is in at least one predetermined direction; and
   the at least one predetermined direction is 45° to the first direction.
An embodiment wherein:
   the deforming the TMM comprises applying shear in the first direction;
   the second thermal expansion characteristic subsequent to deformation is in at least one predetermined direction; and
   the at least one predetermined direction is 45° to the first direction.
An embodiment wherein:
   the PFD is defined by multiple the PTASOS elements configured into an optical telescope assembly (OTA);
   the FMT and the SMT axes of the PTASOS in the OTA are aligned parallel to the optical axis of the OMS;
   the OTA is axially symmetric along the optical axis of the OMS;
   the OTA is configured to attached directly or indirectly to the OMS; and
   the OTA is configured to separate the OMS and the OFT along the COA and define a predetermined distance between the MRS and the FRP.
An embodiment wherein:
   the PFD is defined by multiple the PTASOS elements configured into an optical telescope assembly (OTA);
   the FMT and the SMT axes of the PTASOS in the OTA are aligned at a pre-determined angle to the optical axis of the OMS;
   the OTA is axially symmetric along the optical axis of the OMS;
   the OTA is configured to attached directly or indirectly to the OMS; and
   the OTA is configured to separate the OMS and the OFT along the COA and define a predetermined distance between the MRS and the FRP.
An embodiment wherein:
   the PFD is defined by multiple the PTASOS elements configured into an optical telescope assembly (OTA);
   the FMT and the SMT axes of the PTASOS in the OTA are aligned parallel to the optical axis of the OMS;
   the OTA is not axially symmetric along and off-axis to the optical axis of the OMS;
   the OTA is configured to attached directly or indirectly to the OMP; and
   the OTA is configured to separate the OMS and the OFT along the COA and define a predetermined distance between the MRS and the FRP.

One skilled in the art will recognize that other embodiments are possible based on combinations of elements taught within the above invention description.

### CONCLUSION

A series tailored athermally stabilized optical (STASO) telescope and method (STASOM) has been disclosed. The disclosed system/method separates an optical mirror source (OMS) and an optical focal target (OFT) via a series connection of a first metering tube (FMT) and a second metering tube (SMT) that have been selected to have complementary thermal expansion characteristics so as to keep the OMS and OFT at a predetermined optical focal distance (OFD) from one another. This OFD may constitute a static distance and/or may incorporate a positive and/or negative expansion with temperature that complements thermal characteristics of the OMS and/or OFT so as to stabilize the OFD between the OMS and OFT over a predetermined range of temperatures.

### Claims Interpretation

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112 (f) and such claim shall be construed to cover the corresponding structure, material, or acts described in the specification and equivalents thereof.
The phrase “MEANS FOR” specifically invokes the means-plus-function claims limitation recited in 35 U.S.C. § 112 (f) and such claim shall be construed to cover the corresponding structure, material, or acts described in the specification and equivalents thereof.
The phrase “STEP FOR” specifically invokes the step-plus-function claims limitation recited in 35 U.S.C. § 112 (f) and such claim shall be construed to cover the corresponding structure, material, or acts described in the specification and equivalents thereof.
The step-plus-function claims limitation recited in 35 U.S.C. § 112 (f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

Although a preferred embodiment of the present invention has been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A series tailored athermally stabilized optical (STASO) telescope system comprising:
(a) optical mirror source (OMS);
(b) optical focal target (OFT);
(c) first metering tube (FMT); and
(d) second metering tube (SMT);
wherein:
said OMS comprises a mirror reference surface (MRS) perpendicular to an optical axis (OAX) of said OMS;
said OFT comprises a focal reference plane (FRP) aligned to said OAX said OFT;
said FMT comprises a material having a first thermal expansion (FTE) coefficient;
said SMT comprises a material having a second thermal expansion (STE) coefficient;
said FMT and said SMT are aligned along a common optical axis (COA);
said FMT and said SMT are configured to align said OMS and OFT along said COA;
said FMT and said SMT are configured to separate said OMS and said OFT along said COA and define a predetermined focal distance (PFD) between said MRS and said FRP;
said FMT is constructed from a thermalized metallic material (TMM) selected to produce in combination with said SMT a thermally controlled optical (TCO) variation in said PFD;
said TMM is constructed by deforming a metallic material by applying tension in a first direction;
said TMM, subsequent to said deformation, exhibits a first thermal expansion characteristic having a coefficient of thermal expansion within a predetermined range;
said coefficient of thermal expansion is in at least said first direction;
said TMM, subsequent to said deformation, exhibits a second thermal expansion characteristic in a second direction; and
wherein said TMM comprises a material selected from a group consisting of:
(1) a material characterized by a general formula Ti_{100-A}X_{A}, wherein X is at least one of Ni, Nb, Mo, Ta, Pd, Pt, or combinations thereof, and A is in a range from 0 to 75 atomic percent composition;
(2) a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
(3) a material characterized by a general formula Ti_{100-A-B}Nb_{A}X_{B}, wherein X is at least one of Al, Sn, Ta, Hf, Zr, Al, Au, Pt, Fe, Co, Cr, Mo, V, O, or combinations thereof, and A is in a range from 0 to 55 atomic percent composition, and B is in a range from 0 to 75 atomic percent composition such that A plus B is less than 100; and
(4) a material characterized by a general formula Ti_{100-A-B}Ta_{A}X_{B}, wherein X is at least one of Al, Sn, Nb, Zr, Mo, Al, Au, Pt, Fe, Co, Cr, Hf, V, O, or combinations thereof, and A is in a range from 0 to 55 atomic percent composition, and B is in a range from 0 to 75 atomic percent composition such that A plus B is less than 100.

2. The system of claim 1 wherein said deformation is achieved by at least one of:
(1) hot-rolling;
(2) cold-rolling;
(3) plane strain compression;
(4) bi-axial tension;
(5) conformal processing;
(6) bending;
(7) drawing;
(8) wire-drawing;
(9) swaging;
(10) extrusion;
(11) equal channel angular extrusion;
(12) precipitation heat treatment under stress;
(13) annealing;
(14) sintering;
(15) monotonic tension processing;
(16) monotonic compression processing;
(17) monotonic torsion processing;
(18) cyclic thermal training under stress; and
(19) combinations thereof.

3. The system of claim 1 wherein said predetermined range of said coefficient of thermal expansion ranges from −150×10⁻⁶K⁻¹ to +500×10⁻⁶K⁻¹.

4. The system of claim 1 wherein said deforming of said metallic material further comprises texturing said metallic material in a direction comprising at least one of a [111], a [100], or a [001] direction.

5. The system of claim 1 wherein said TMM comprises a material having a negative thermal expansion (NTE) coefficient.

6. The system of claim 1 wherein:
said deforming said TMM comprises applying tension in at least one direction; and
said second thermal expansion characteristic subsequent to said deformation is in at least one direction.

7. The system of claim 1 wherein:
said deforming said TMM comprises applying compression in first direction;
said second thermal expansion characteristic subsequent to said deformation is in at least one predetermined direction; and
said at least one predetermined direction is perpendicular to said first direction.

8. The system of claim 1 wherein:
said deforming said TMM comprises applying shear in said first direction;
said second thermal expansion characteristic subsequent to deformation is in at least one predetermined direction; and
said at least one predetermined direction is 45° to said first direction.

9. A series tailored athermally stabilized optical (STASO) telescope method comprising:
(1) configuring a first metering tube (FMT) and a second metering tube (SMT) in series combination to separate an optical mirror one (OMS) and an optical focal target (OFT);
(2) configuring said FMT, said SMT, said OMS, and said OFT along a common optical axis (COA); and
(3) configuring said FMT, said SMT to separate said OMS and said OFT along said COA to define a predetermined focal distance (PFD) between a mirror reference surface (MRS) perpendicular to an optical axis of said OMS and a focal reference plane (FRP) aligned to an optical axis of said OFT;
wherein:
said FMT comprises a material having a first thermal expansion (FTE) coefficient;
said SMT comprises a material having a second thermal expansion (STE) coefficient;
said FMT is constructed from a thermalized metallic material (TMM) selected to produce in combination with said SMT a thermally controlled optical (TCO) variation in said PFD;
said TMM is constructed by deforming a metallic material by applying tension in a first direction;
said TMM, subsequent to said deformation, exhibits a first thermal expansion characteristic having a coefficient of thermal expansion within a predetermined range;
said coefficient of thermal expansion is in at least said first direction;
said TMM, subsequent to said deformation, exhibits a second thermal expansion characteristic in a second direction; and
wherein said TMM comprises a material selected from a group consisting of:
a material characterized by a general formula Ti_{100-A}X_{A}, wherein X is at least one of Ni, Nb, Mo, Ta, Pd, Pt, or combinations thereof, and A is in a range from 0 to 75 atomic percent composition;
a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
a material characterized by a general formula Ti_{100-A-B}Nb_{A}X_{B}, wherein X is at least one of Al, Sn, Ta, Hf, Zr, Al, Au, Pt, Fe, Co, Cr, Mo, V, O, or combinations thereof, and A is in a range from 0 to 55 atomic percent composition, and B is in a range from 0 to 75 atomic percent composition such that A plus B is less than 100; and
a material characterized by a general formula Ti_{100-A-B}Ta_{A}X_{B}, wherein X is at least one of Al, Sn, Nb, Zr, Mo, Al, Au, Pt, Fe, Co, Cr, Hf, V, O, or combinations thereof, and A is in a range from 0 to 55 atomic percent composition, and B is in a range from 0 to 75 atomic percent composition such that A plus B is less than 100.

10. The method of claim 9 wherein said deforming is achieved by at least one of:
(1) hot-rolling;
(2) cold-rolling;
(3) plane strain compression;
(4) bi-axial tension;
(5) conformal processing;
(6) bending;
(7) drawing;
(8) wire-drawing;
(9) swaging;
(10) extrusion;
(11) equal channel angular extrusion;
(12) precipitation heat treatment under stress;
(13) annealing;
(14) sintering;
(15) monotonic tension processing;
(16) monotonic compression processing;
(17) monotonic torsion processing;
(18) cyclic thermal training under stress; and
(19) combinations thereof.

11. The method of claim 9 wherein said predetermined range of said coefficient of thermal expansion ranges from −150×10⁻⁶K⁻¹ to +500×10⁻⁶K⁻¹.

12. The method of claim 9 wherein said deforming of said TMM further comprises texturing said metallic material in a direction comprising at least one of a [111], a [100], or a [001] direction.

13. The method of claim 9 wherein said FMT comprises a material having a negative thermal expansion (NTE) coefficient.

14. The method of claim 9 wherein the sum of said FTE coefficient and said STE coefficient is zero.

15. The method of claim 9 wherein:
said deforming said TMM comprises applying tension in at least one direction; and
said second thermal expansion characteristic subsequent to said deformation is in at least one direction.

16. The method of claim 9 wherein:
said deforming said TMM comprises applying compression in said first direction;
said second thermal expansion characteristic subsequent to said deformation is in at least one predetermined direction; and
said at least one predetermined direction is perpendicular to said first direction.

17. The method of claim 9 wherein:
said deforming said TMM comprises applying shear in said first direction;
said second thermal expansion characteristic subsequent to deformation is in at least one predetermined direction; and
said at least one predetermined direction is 45° to said first direction.

18. The method of claim 9 wherein:
said PFD is defined by multiple said PTASOS elements configured into an optical telescope assembly (OTA);
said FMT and said SMT axes of said PTASOS in said OTA are aligned parallel to the optical axis of said OMS;
said OTA is axially symmetric along the optical axis of said OMS;
said OTA is configured to attached directly or indirectly to said OMS; and
said OTA is configured to separate said OMS and said OFT along said COA and define a predetermined distance between said MRS and said FRP.

19. The method of claim 9 wherein:
said PFD is defined by multiple said PTASOS elements configured optical into an telescope assembly (OTA);
said FMT and said SMT axes of said PTASOS in said OTA are aligned at a pre-determined angle to the optical axis of said OMS;
said OTA is axially symmetric along the optical axis of said OMS;
said OTA is configured to attached directly or indirectly to said OMS; and
said OTA is configured to separate said OMS and said OFT along said COA and define a predetermined distance between said MRS and said FRP.

20. The method of claim 9 wherein:
said PFD is defined by multiple said PTASOS elements configured optical into an telescope assembly (OTA);
said FMT and said SMT axes of said PTASOS in said OTA are aligned parallel to the optical axis of said OMS;
said OTA is not axially symmetric along and off-axis to the optical axis of said OMS;
said OTA is configured to attached directly or indirectly to said OMP; and
said OTA is configured to separate said OMS and said OFT along said COA and define a predetermined distance between said MRS and said FRP.

21. The method of claim 9 wherein:
said PFD is defined by multiple said PTASOS elements configured into an optical telescope assembly (OTA);
said FMT and said SMT axes of said PTASOS in said OTA are aligned at a pre-determined angle to the optical axis of said OMS;
said OTA is not axially symmetric along and off-axis to the optical axis of said OMS;
said OTA is configured to attached directly or indirectly to said OMS; and
said OTA is configured to separate said OMS and said OFT along said COA and define a predetermined distance between said MRS and said FRP.
